(19) United States
(12) Patent Application Publication
(10) Pub. No.: US 2026/0302588 A1
(43) Pub. Date: Oct. 1, 2026

(54) PRESSURE VESSEL ANTENNAS AND CONTAINERS FOR ELECTRONIC CIRCUITRY

(71) Applicant: University of Kansas, Lawrence, KS (US)

(72) Inventors: Mark STOCKMAN, Lawrence, KS (US); Allen HASE, Lawrence, KS (US); David BESSON, Lawrence, KS (US); Scott VOIGT, Lawrence, KS (US)

(21) Appl. No.: 19/631,032

(22) Filed: Mar. 27, 2026

Related U.S. Application Data
(60) Provisional application No. 63/779,533, filed on Mar. 28, 2025.

(51) Int. Cl. H01Q 1/04; E21B 47/017; E21B 47/13; H01Q 1/50; H01Q 9/16

(52) U.S. Cl. CPC H01Q 1/04; E21B 47/017; E21B 47/13; H01Q 1/50; H01Q 9/16

(57) ABSTRACT

This disclosure provides for pressure vessel antennas and pressure vessel containers for electronic circuitry. A pressure vessel antenna includes a first tube having a first cone removably affixed to an end of the first tube, and a second tube comprising a second cone removably affixed to an end of the second tube. The first tube and the second tube form a dipole antenna by each being coupled to a conductor of a feed cable extending between the first cone and the second cone. The first tube and the second tube are separated by a fixed distance using a spacer. The pressure vessel antenna includes an electronic circuitry disposed in the first tube, where the electronic circuitry is connected to the feed cable.

### CROSS-REFERENCE TO RELATED APPLICATIONS

This application claims priority to U.S. Provisional Patent App. No. 63/779,533 and filed Mar. 28, 2025, the contents of which are incorporated by reference herein.

### GOVERNMENT LICENSE RIGHTS

This invention was made with government support under grant nos. 1002483 and 1359535 awarded by the National Science Foundation. The government has certain rights in the invention.

### FIELD

This disclosure generally relates to antenna systems, and specifically to pressure vessel antennas utilizing specialized containers for housing electronic circuitry thereof.

### BACKGROUND

In various contexts, radio frequency (RF) transmission and/or receiving is performed in a high-pressure environment. Despite the difficulties posed by the high-pressure environment, some or all of the electronic components are to be held at atmospheric pressure for use. In addition to securely storing the electronic circuitry, the chamber may affect the capacities of such RF components, but is desired to not have any negative effect on the RF operation of the components themselves.

Existing implementations for containing electronic circuitry, including RF signal producing and/or receiving components, for antennas in high pressure environments fail to sufficiently address the hurdles posed by these environments. Thus, a sufficient pressure vessel antenna (and/or associated container for storing electronic circuitry in the environment) is desired.

### SUMMARY

In accordance with one aspect of the disclosure, a pressure vessel antenna is provided. An example pressure vessel antenna (PVA) includes a first tube comprising a first cone removably affixed to an end of the first tube, and a second tube comprising a second cone removably affixed to an end of the second tube. The first tube and the second tube form a dipole antenna by each being coupled to a conductor of a feed cable extending between the first cone and the second cone. The first tube and the second tube are separated by a fixed distance using a spacer. The example PVA further includes electronic circuitry disposed in the first tube, wherein the electronic circuitry is connected to the feed cable.

In some embodiments of the example PVA, a full length of the PVA is tuned to a resonant frequency produced via the electronic circuitry.

In some embodiments of the example PVA, a diameter of the PVA corresponds to a borehole diameter, and a signal bandwidth produced via the electronic circuitry is based at least in part on the diameter of the PVA.

In some embodiments of the example PVA, the first tube includes tube at a first pressure, and the second tube includes an open tube at a second pressure, wherein the first pressure differs from the second pressure.

In some embodiments of the example PVA, the first tube and the second tube taper at an angle to a feedpoint corresponding to the feed cable. In some such embodiments of the example PVA, the angle is in a range between 40 degrees and 75 degrees.

In some embodiments of the example PVA, the PVA further includes at least one battery extension compartment removably affixed to the first tube, where the at least one battery extension compartment comprises at least one battery that powers the electronic circuitry.

In some embodiments of the example PVA, the spacer comprises a sealed interior cavity.

In some embodiments of the example PVA, the first cone and the second cone are removably affixed using a removable attachment mechanism. In some such embodiments of the example PVA, the removable attachment mechanism comprises a set of interlocking threads.

In some embodiments of the example PVA, the PVA further includes a ballast.

In some embodiments of the example PVA, the second tube further includes an air hole positioned at an upper section of the second tube, where the air hole enables air flow to escape from inside the second tube.

In some embodiments of the example PVA, the first tube comprises an electronic communications port.

In some embodiments of the example PVA, the PVA further includes at least one extension section removably affixed to the first tube or the second tube by at least one coupler.

In some embodiments of the example PVA, the PVA further includes a durable polymer end cap removably affixed to the first tube. In some embodiments of the example PVA, the first cone includes an aluminum cone.

In accordance with another aspect of the disclosure, a pressure vessel antenna container is provided. The pressure vessel antenna container (or “pressure vessel container”) is a housing for a pressure vessel antenna, as described herein. An example pressure vessel antenna container includes a first tube including a first cone removably affixed to an end of the first tube, and a second tube including a second cone removably affixed to an end of the second tube. The example pressure vessel antenna container further includes a spacer between the first tube and the second tube, wherein the spacer separates the first tube and the second tube by a fixed distance. The example pressure vessel antenna container further includes a feedpoint on the spacer, wherein the feedpoint is between the first tube and the second tube.

In some embodiments of the example pressure vessel antenna container, the first cone is aluminum.

In some embodiments of the example pressure vessel antenna container, the pressure vessel antenna container further includes a durable polymer end cap removably affixed to the first tube.

In some embodiments of the example pressure vessel antenna container, the diameter of the pressure vessel antenna container fits within a borehole.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 illustrates deconstructed components of an example pressure vessel container, for example utilized in housing electronic components of a pressure vessel antenna, in accordance with at least one embodiment of the present disclosure;

FIG. 2 illustrates an exploded view of arranged components of an example pressure vessel antenna in accordance with at least one embodiment of the present disclosure;

FIG. 3 illustrates a zoomed view of components at a feedpoint of an example pressure vessel antenna in accordance with at least one embodiment of the present disclosure;

FIG. 4 illustrates components of a formed pressure vessel antenna in accordance with at least one embodiment of the present disclosure;

FIG. 5 illustrates a sliced internal view depicting components of a formed pressure vessel antenna in accordance with at least one embodiment of the present disclosure;

FIGS. 6A-6B illustrate an exploded view of components with particular materials of another pressure vessel container, for example utilized in housing electronic components of a pressure vessel antenna, in accordance with at least one embodiment of the present disclosure;

FIGS. 7A-7D illustrate extracted, zoomed views of a feedpoint location of an example pressure vessel antenna in accordance with at least one embodiment of the present disclosure;

FIGS. 8A-8C illustrate extracted, zoomed views of example cones utilized in example pressure vessel containers in accordance with at least one embodiment of the present disclosure;

FIG. 9 illustrates an extracted, zoomed view of coupled extension sections of an example pressure vessel container in accordance with at least one embodiment of the present disclosure;

FIG. 10 illustrates an end cap having a communications portion of an example pressure vessel antenna in accordance with at least one embodiment of the present disclosure; and

FIG. 11 illustrates an example environment in which a pressure vessel antenna is deployed in accordance with at least one embodiment of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

### I. EXAMPLE USE CASE

This disclosure provides various examples related to pressurized vessel antennas and related containers (e.g., “pressure vessel containers”) that house electronic components (e.g., RF signal producing and/or receiving components). In various contexts, an antenna, for RF properties, is to be physically nearly as large as the pressurized space it is in (for example, a borehole). In such circumstances, it becomes difficult to make a non-metal chamber with thick enough walls so that the pressure vessel container housing the electronic components (e.g., RF signal producing and/or receiving components) is strong enough to withstand the pressure of such an environment.

Embodiments of the present disclosure include specially designed pressure vessel antennas and pressure vessel containers for housing electronic circuitry (e.g., RF signal producing and/or receiving components) thereof. Specifically, some embodiments include one half of the pressure vessel antenna into a pressure chamber, for example that houses electronic circuitry for producing a radio frequency signal. By turning one half of the pressure vessel antenna itself into the pressure chamber itself, the container may be made strong enough for pressurized environments even with relatively thin walls. Thin walls allow for the maximum space for electronics on the inside, simultaneously allowing the pressure vessel antenna to be fit within a small and/or well-defined space (e.g., a borehole). The self-contained electronic components, for example battery power and signal generation circuitry, avoids the losses associated with long cables. In this regard, embodiments of the present disclosure advantageously are designed to maximally fit desired spaces while simultaneously maintaining operational effectiveness for radio frequency transmission.

Embodiments of the present disclosure have notable improved structural integrity in pressurized environments. Embodiments of the present disclosure have been successfully tested to 300 atmospheres in a testing chamber and 170 atmospheres in a liquid-filled borehole. Such implementations are notable over existing designs.

Embodiments of the present disclosure additionally are highly scalable and modular, particularly as compared to existing designs. In this regard, a foundational container design (e.g., two antenna halves, one being a pressure chamber) can be made of varying pipe diameters and with varying lengths of pipe sections to tune the resonant frequency of the antenna. In some embodiments, to ensure a secure connection while providing such modularity, each section threads into another section and in some embodiments contains a static gland seal. Embodiments of the present disclosure may thus meet any of a myriad of defined spaces and use cases.

Embodiments of the present disclosure may be deployed for any of a myriad of use case and in any of a myriad of distinct environments. For example, radio frequency (“RF”) antenna deployment in polar ice is utilized for an active research area in physics and astronomy. In this regard, there are many existing fluid-filled boreholes that, in order to be re-used to perform RF calibration measurements, may be usable only with a pressurized chamber and antenna. These same holes coupled with a pressure vessel antenna in accordance with embodiments of the present disclosure can probe the properties of the ice itself. Additionally or alternatively, by having many antennas at varying depths and locations inside of boreholes (even if the hole is filled with water, oil, anti-freezing fluid), radio signals can be broadcast and received to measure the nature of the volume between the boreholes as well as if there are any shadowing effects due to large inhomogeneities in the volume. Such embodiments provide support for various fields of research and use, including but not limited to hydrocarbon and mineral deposit exploration.

Embodiments of the present disclosure may include pressure vessel containers and/or pressure vessel antennas that include components designed to specific material specifications. For example, in some embodiments, the body of each antenna body element is an aluminum tube with female threads and a cylindrical bore on each end. One end accepts a cap with matching male threads and an o-ring groove designed to seal against the bore in the end of the tube. The other end connects to the center cone in the same fashion. The two center cones in some embodiments differ only in their central through holes. The cone on the side with the electronics has a larger hole, which allows the feed cable to pass through. The outer shield of the cable is electrically connected to this cone. The core of the cable extends into a smaller hole in the point of the other cone and is attached mechanically and electrically with set screws. Both cones taper down to the feedpoint with a particular angle (e.g., a 72 degree included angle), defining a usable space for electronic circuitry, connections, and/or the like.

The spacing between the two antenna elements in some embodiments is set with a nylon center sleeve. The nylon center sleeve in some embodiments has conical bores on each end, for example designed to accept the aluminum cones. In this regard, when constructed into a pressure vessel container and/or pressure vessel antenna, the cones seat into the nylon sleeve and are secured with screws that pass radially through the nylon and into threaded holes in the cones. The center sleeve has a large window cut away to allow access to the feedpoint for assembly (e.g., to include a feed cable at the feedpoint). In some embodiments, the area defining the feedpoint may be sealed up construction, such as after inclusion of the feed cable. For example, in some embodiments epoxy can be poured through this window into the area around the feedpoint to seal out liquid and/or provide extra strength.

In some embodiments that utilize aluminum tubes, the aluminum tubes that form the body of each half of the dipole can be welded from multiple pieces. Such implementations allow threaded ends to be added to lengths of tube that are too long to fit in a normal lathe. Threaded extensions can be added between the antenna tube and the end cap to add length to the pressure vessel container and/or pressurized vessel antenna. Additionally or alternatively, in some embodiments extensions (e.g., aluminum extensions) may be included that increase the length of the dipole to optimize it for lower frequencies. Nylon extensions may additionally or alternatively be used, and do not affect the radio performance of the antenna, but provide extra room inside the vessel to fit electronic equipment. Additionally or alternatively, in some embodiments brass couplers may be used for mating thread for aluminum. These couplers in some embodiments are similarly made of aluminum, for example together with precautions to avoid galling and/or cold welding of the aluminum pieces together. Other alloys, plating (e.g., anodizing), or an anti-seize lubricant may be used to facilitate assembly in other embodiments.

Some embodiments include a feedpoint attachment that comprises braided coaxial cable shields that can be stripped back, twisted into bundles, and secured to the outside of the aluminum cone using screws. In some embodiments, helical shields are threaded into the cone directly with custom female threads that are cut to match. It should be appreciated that any type of cable may be locked in place with set screws. Additionally or alternatively, in some embodiments the insulation is stripped back on the cable such that these set screws can also provide an electrical connection.

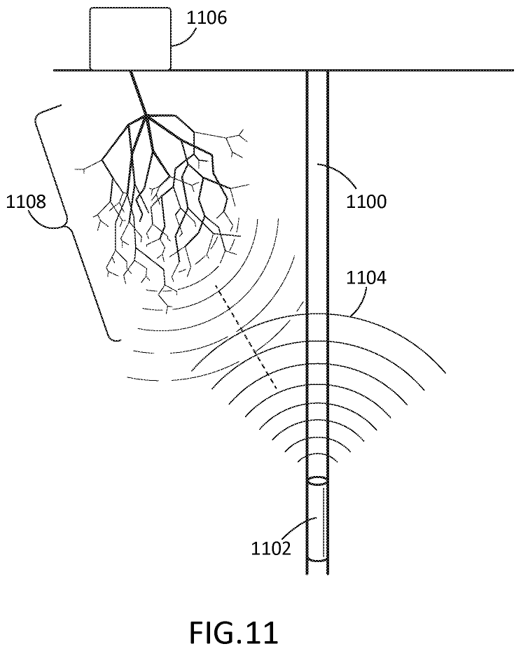

FIG. 11 illustrates an example environment in which a pressure vessel antenna is deployed in accordance with at least one embodiment of the present disclosure. In this regard, it should be appreciated that embodiments of the present disclosure may be deployed in the environment depicted and described with respect to FIG. 11, for example.

FIG. 11 specifically depicts an example pressure vessel antenna 1102 deployed in a borehole 1100. In some embodiments, the borehole 1100 embodies a fluid-filled borehole in a glacial or other frozen environment. For example, accurate and precise characterization of RF response of glacial firn may be desired in particular contexts, and thus the measuring of RF signal propagation may be used to study a particular glacial environment. In some embodiments, the borehole 1100 may be filled with water, oil, or another fluid, whether naturally occurring or inserted into the borehole 1100. The borehole 1100 in some such embodiments may form a pressurized environment, for example such that pressure that exceeds a surface-level pressure is exerted on any object in the borehole 1100 at a particular depth. In this regard, objects inserted into the borehole 1100, for example the pressure vessel antenna 1102, must be configured to withstand such an increased pressure while continuing to operate effectively. In some embodiments, multiple pressure vessel antennas are disposed in the same borehole, and/or multiple pressure vessel antennas may be disposed throughout multiple boreholes.

In some embodiments, the pressure vessel antenna 1102 includes any number of electronic components (e.g., RF signal producing and/or receiving components) that supports RF transmission and/or reception. For example, as illustrated, the pressure vessel antenna 1102 is configured to perform RF communication 1104, which may include RF transmission capabilities and/or RF reception capabilities. In some embodiments, the pressure vessel antenna 1102 performs the RF communication 1104 to facilitate wireless communication with a surface-level system, for example the surface system 1106. The surface system 1106 and the pressure vessel antenna 1102 in some embodiments communicate for any one or more of a myriad of reasons, such as to communicate instructions to the pressure vessel antenna 1102 that are utilized to control operations of the pressure vessel antenna 1102, communicate measurements captured by circuitry onboard the pressure vessel antenna 1102, and/or the like. In some embodiments, the surface system 1106 collects, stores, and/or processes information communicated from the pressure vessel antenna 1102.

In one example context, the surface system 1106 to perform a radio detection scheme in which a high energy particle is transmitted into the environment (e.g., glacial ice), which creates a particle cascade 1108. The particle cascade emits a radio pulse within the ice, where the pressure vessel antennas within the ice (e.g., the pressure vessel antenna 1102 in the borehole 1100) are sensitive. The pressure vessel antenna 1102 may emit a response upon receiving such a radio pulse, for example where the response comes in the form of RF communication 1104 and is configured based on the specific signal received by the pressure vessel antenna itself. In one example context, the pressure vessel antenna 1102 monitor large volumes and are sensitive to low ultra-high energy neutrino flux, for example at energies of approximately 100 PeV and/or above. In this regard, abundant, high purity polar ice may provide a dense target medium of O(1 km) RF attenuation lengths. However, such sites where a surface system 1106 may be located are often far from anthropogenic noise backgrounds, such that other communication mechanisms for such purposes are unusable.

The pressure vessel antenna 1102 may be configured in such contexts to accurately and precisely characterize the RF response of the glacial firn, for example by observation of neutrinos using RF techniques. UHEN may be detected by measuring radio signals induced by hadronic or electromagnetic showers. In some embodiments, a parameter representing an index of refraction is determined, which determines the speed of light in different media and dictates the propagation of radio in the glacial firn. In this regard, as UHEN interacting in the particle cascade 1108, electrons annihilate with positrons and are Compton scattered into the shower, causing the cascade to acquire a net negative charge. This time-varying net-excess charge creates coherent Cherenkov radiation (or “the Askaryan effect”), which is experimentally detectable. In this regard, the components depicted and described in FIG. 11 may be used to extract a local index of refraction profile and/or probe borehole closure by translating measured changes in antenna responses into properties of the local environment for a pressure vessel antenna. It should be appreciated that, in some embodiments, the pressure vessel antenna 1102 broadcasts signals. For example, in some embodiments, the pressure vessel antenna 1102 broadcasts a known calibration signal that travels through a volume to surface system 1106. For example, the pressure vessel antenna 1102 in some embodiments is used to mimic signal types that are produced by the Askaryan effect. In this regard, the pressure vessel antenna 1102 may be utilized to inform calibrated treatment of a signal produced by the UHEN, and additionally or alternatively to characterize the ice volume (or other environment) through which the signals traverse.

The pressure vessel antenna 1102 may be lowered into the borehole 1100 and measurements taken as the pressure vessel antenna 1102 is lowered. For example, in some embodiments, the pressure vessel antenna 1102 is utilized to collect impedance data at 1 m increments. Such measurements may be processed to determine insights with respect glacial ice construction, and/or the like, such as by identifying depths at which RF signals captured by the pressure vessel antenna 1102 become anomalous.

In this regard, the pressure vessel antenna 1102 may be specially configured to serve a myriad of purposes. First, the pressure vessel antenna 1102 is configured to fit within the borehole 1100. Second, the pressure vessel antenna 1102 is configured to fit electronic components (e.g., RF signal producing and/or receiving components) in a pressure-stabilized environment while sufficiently withstanding the external pressurized environment of the borehole 1100. Third, the pressure vessel antenna 1102 is configured to ensure that RF signal producing and/or receiving components remain operable therein for RF communication 1104 while positioned within the borehole 1100. Fourth, the pressure vessel antenna 1102 is configured to perform in a sealed manner, such that functionality of the pressure vessel antenna 1102 is maintained regardless of whether the borehole 1100 is empty or fluid-filled.

The configuration of the pressure vessel antenna 1102 as depicted and described herein provides these various advantages. Specifically, the pressure vessel antenna 1102 may be designed in a particular manner, including a pressure vessel container that has two tubular subassemblies interfaced (e.g., by being removably affixed) to a spacer. Half of the pressure vessel container may define a sealed, pressure-stabilized internal cavity that enables positioning of electronic circuitry (e.g., RF signal producing and/or receiving components) in a safe environment. Another half to the pressure vessel container may be unsealed and/or open, and may not store any such components. The pressurized half (e.g., a top subassembly) may be modularly designed to facilitate a desired length, where the length of the pressure vessel antenna and/or a particular subassembly thereof is used to tune a resonant frequency of the pressure vessel antenna to a target band. In some embodiments, the two sub-assemblies of the pressure vessel container are connected via a feed cable at a feedpoint, for example that spans a distance defined by a spacer size between the two sub-assemblies. The feed cable may be utilized to configure the whole of the pressure vessel container to be utilized for enhancing RF transmission within a certain target band.

The particular configuration of components therein may be utilized to fit desired electronic circuitry (e.g., RF signal producing and/or receiving components), for example where a tube is used to house a first set of RF signal producing and/or receiving components, optional battery extension compartments may be included that store batteries for powering the RF signal producing and/or receiving components, a cone-tip of a subassembly may be included having a tapered shape to provide additional space for RF signal producing and/or receiving components, and/or the like.

The components of the pressure vessel container embodying the housing of the pressure vessel antenna 1102 may be designed to enable use within the borehole 1100. For example, in some embodiments, different components are designed of different materials that are sufficiently constructed to withstand the pressurized environment of the borehole 1100 and not diminish operation of the RF communication 1104. For example, certain components of the pressure vessel antenna 1102 may be embodied as an aluminum construction (e.g., a tube and cone tip of one or two sub-assemblies), while other components of the pressure vessel antenna may be embodied as a nylon construction (e.g., a cap and a spacer) to ensure that the pressure vessel antenna 1102 is sufficiently robust to withstand the environment of the borehole 1100 and functions for RF communication 1104 while positioned within the borehole 1100. The conductive elements (e.g., the aluminum components) may thus impact the RF bandwidth and/or capabilities, whereas the other components (e.g., the nylon or other robust polymer components) may not.

In some embodiments, the pressure vessel antenna 1102 includes a ballast. The ballast may be positioned on a bottom of the pressure vessel container of the pressure vessel antenna 1102, for example. In this regard, the ballast may assist in controlling a descent of the pressure vessel antenna 1102 within the borehole 1100. Additionally or alternatively, in some embodiments, the ballast provides improved stability of the pressure vessel antenna 1102 within the borehole 1100, for example to support a desired orientation of the pressure vessel antenna 1102.

### II. WITH REFERENCE TO THE FIGURES

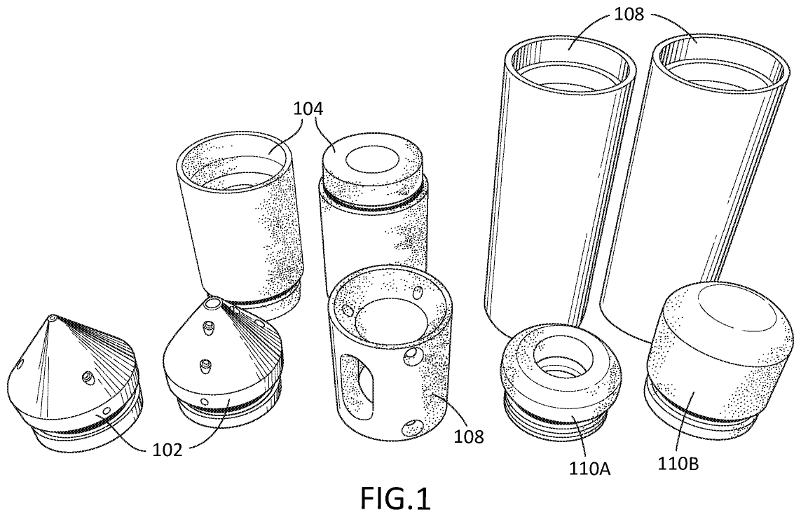

FIG. 1 illustrates deconstructed components of an example pressure vessel container, for example utilized in housing electronic components of a pressure vessel antenna, in accordance with at least one embodiment of the present disclosure. The various illustrated components may be assembled to form a pressure vessel container from the combination thereof. In this regard, electronic circuitry (e.g., RF signal producing and/or receiving components) may be included or otherwise housed within the pressure vessel container to form a pressure vessel antenna. The pressure vessel antenna may be functional to perform as a radio frequency antenna within a pressurized environment, for example from within a borehole.

The components include a plurality of tubes 108. The plurality of tubes 108 each are cylindrical in shape and form an interior cavity. The plurality of tubes 108 each receive a cone of the plurality of cones 102. In this regard, a cone of the plurality of cones 102 may serve as a cap to one side of a corresponding tube of the plurality of tubes 108. In some embodiments, the cone of the plurality of cones 102 are configured to removably affix to a corresponding tube of the plurality of tubes 108. For example, in some embodiments, each cone is threaded in a manner corresponding to threads on a corresponding tube, such that the threaded ends of the two components form an interlocking thread set that interface to removably affix the components together. In some embodiments, the cone and the tube further include at least one o-ring that supports a seal between the tube and the cone, for example to ensure a pressurized seal at the point of contact between the threads. Additionally or alternatively still, in some embodiments, a cone of the plurality of cones 102 includes at least one removable attachment mechanism (e.g., at least one set screw or other securing fastener) that, when engaged, sets the cone in a removably affixed position with respect to a corresponding tube of the plurality of tubes 108. The at least one removable attachment mechanism may, when re-engaged in an opposite manner, remove the affixation of the cone to the corresponding tube. In some embodiments, the removable attachment mechanism is embodied by the set of interlocking threads of the two components, which may engage one another when the pressure vessel container of the pressure vessel antenna is assembled.

In some embodiments, the plurality of cones 102 each taper at a particular angle to a feedpoint. The feedpoint corresponds to a location where a feed cable is ran between the plurality of cones, as discussed further herein. For example, in some embodiments, the plurality of cones 102 each taper at an angle in a range between 40 degrees and 75 degrees. A preferred angle that provides sufficient or maximized component space within an internal cavity of a spacer may be utilized in some embodiments, for example a taper angle of 72 degrees.

The cone-end of the cone fixedly attached to the tube may feed into a spacer 106, such that two cone-end tubes are removably affixed to the spacer 106. The spacer 106 receives a cone of the plurality of cones when removably affixed to a tube of the plurality of tubes 108 and orients the combined cone-tipped tube such that each cone-tipped tube is spaced from the other by a fixed distance. The space formed by the fixed distance enables one or more components to be positioned between the two cone-tipped tubes. For example, a feed cable may be ran between the plurality of cones 102, such that the feed cable connects the two cone-tipped tube constructions. In some embodiments, the spacer 106 includes a window that enables insertion of and/or access to a feed cable without removal and/or deconstruction of the combined components. Additionally or alternatively, the distal shape of the plurality of cones 102 defines additional space between the two cone-tipped tubes, where electrical circuitry and/or other components may be positioned within the open space. Additionally or alternatively, in some embodiments, one or more other components may be positioned within the space between the cone-tipped tubes.

In some embodiments, each tube of the plurality of tubes 108 may be configured differently at an end opposite the cone-tipped end based on one or more factors. For example, in some embodiments, an end of the tube that is positioned towards a top of the pressure vessel container may include an extension that is configured to store at least one battery and/or one or more other RF signal producing and/or receiving components. For example, in some embodiments, a tube is fixedly attached to at least one extension container of the plurality of extension containers 104. In some embodiments, the plurality of extension containers 104 are modularly designed such that each extension container may be removably attached to another extension container. In this regard, the plurality of extension containers 104 may be removably attached to one another in series to form a desired total extension area. For example, in some embodiments, each extension container includes a threaded end that is configured to mate with corresponding threads at an opposite end of another extension container. The set of interlocking threads in some embodiments further includes an o-ring or other sealing mechanism (e.g., positioned on grooves between the components) that facilitates an air-tight or liquid-tight seal between the two components connected via the set of interlocking threads. The final extension container may be removably affixed to the tube of the plurality of tubes 108. In one example context, the plurality of extension containers 104 form a battery compartment that is configured to store any number of batteries used in powering RF signal producing and/or receiving components housed in the remainder of the pressure vessel container.

In some embodiments, the constructed first tube (e.g., including a first cone-tip and optionally the plurality of extension containers 104) is capped at a second end by the closed cap 110B. The closed cap 110B enables the constructed first tube to form a pressurized interior chamber. In this regard, RF signal producing and/or receiving components may be positioned within the pressured interior chamber to secure such components from environmental effects during use of such components, for example to provide radio frequency signaling and/or receive radio frequency signaling. In some embodiments, the closed cap 110B is removably attached to end of the tube that does not have the cone. Additionally or alternatively, in circumstances where one or more extension container is removable affixed to the tube, the closed cap 110B may be removable affixed to the extension container, such that the entire combined tube forms a closed, pressurized interior chamber when including the extension containers. In this regard, this half of the pressure vessel container (e.g., which includes the RF signal producing and/or receiving components of a pressure vessel antenna, for example) may form a pressurized container.

The other end of the pressure vessel container may include the other tube of the plurality of tubes 108, for example with a cone tip that faces the other tube as depicted and described herein. In some embodiments, the second tube container is a bottom-side tubular container, such that the bottom-side tubular container is to be positioned lower than the corresponding other half of the pressure vessel container.

As illustrated, in some embodiments, the other subassembly of the pressure vessel container includes an open cap 110A. The open cap 110A is removably affixed to an opposite end of the cone. As illustrated, the open cap 110A includes a missing cavity thereon. In this regard, the interior cavity formed by the subassembly (e.g., within a corresponding tube thereof) remains consistently pressurized with the environment surrounding the pressure vessel container. Additionally or alternatively, the interior cavity of the subassembly (e.g., the cone-tipped tube together with the open cap 110A) may be exposed to environmental effects or elements, such as a liquid that is in the borehole within which the pressure vessel container is placed.

The distinct cap types may be utilized to define different internal cavity environments with respect to the distinct subassemblies. For example, a first tube subassembly that includes a sealed cone tip at one end (discussed further herein) and the closed cap 110B may include a first internal cavity of a first pressure. The first pressure may differ from an environmental pressure that surrounds the pressure vessel container, for example where the pressure is established at a surface level before the pressure vessel antenna is dropped into a borehole. A second tube subassembly that includes a sealed cone tip at one end and the open cap 110A may include a second internal cavity at a second pressure. In this regard, the internal cavity of the second tube subassembly may reach an equilibrium with the environmental pressure of the environment surrounding the pressure vessel antenna. It will be appreciated that, thus in some embodiments, the first pressure differs from the second pressure.

In some embodiments, the components of the pressure vessel container are designed with particular materials. For example, in some embodiments, each tube of the plurality of tubes 108 is constructed of or at least in part constructed of aluminum. Additionally or alternatively, in some embodiments, the spacer, an end cap, and/or an extension container may be constructed of nylon. Such components may be constructed of such materials to enable the various components to hold their desired construction without negatively impacting the operation of the electronic circuitry positioned therein (e.g., electronic circuitry such as RF signal producing and/or receiving components, which facilitates RF signal communication) for radio frequency transmission and/or reception. In some embodiments, a feed cable is connected to one or more other components of electronic circuitry configured to perform RF signal communication.

Antennas emit/receive electromagnetic radiation, converting the emitted (and/or captured energy) to electrical currents. The frequency bandwidth over which an antenna responds depends on antenna construction and geometry. The peak response (or a “resonance”) obtains at a particular frequency f=c/L, with L the characteristic length scale of the antenna itself. An antenna has inductive, capacitive, and resistive characteristics as well, which are utilized to determine the antenna's complex impedance Z_{L} at each frequency. The mismatch between the impedance of an antenna and the impedance of the input/output at the feed determines how well the antenna will radiate and/or respond at a frequency. The “reflection coefficient” Γ is the ratio of the amplitude of the reflected wave and the incident wave in an antenna and provides a measure of the frequency-dependent antenna response. Γ is defined as:

$$Γ = \frac{{Z}_{L} - {Z}_{0}}{{Z}_{L} + {Z}_{0}}$$

where Z_{L} is the antenna input impedance (e.g., complex antenna input impedance), and Z₀ is the transmission line impedance (usually 50Ω and purely real). The magnitude of the reflection coefficient is related to the antenna |S₁₁| parameter via:

$$\vert {S}_{11} \vert ( dB ) = 20 ln ( \vert Γ \vert ) \vert$$

|S₁₁|=0 corresponds to complete power reflection and therefore zero transmission; conversely, S₁₁|→−∞ corresponds to perfect radiation at a given frequency. S₁₁ herein may refer to the magnitude of the |S₁₁| parameter and not the complex value. Resonance occurs at frequencies for which the antenna currents are most coherent along the length of the radiating section of the antenna.

In this regard, a pressure vessel antenna as depicted and described herein may be configured to a particular length that corresponds to a target resonant frequency—where a full length of the pressure vessel antenna (e.g., the length of all components, or at least the length of all conductive components) is tuned to a signal bandwidth to be produced via the electronic circuitry of the pressure vessel antenna. The pressure vessel antenna may be tuned for a signal produced by electronic components of the pressure vessel antenna, or be tuned for signals of interest of the antenna utilized as a receiver, or both. Additionally or alternatively, in some embodiments, signal bandwidth produced via a pressure vessel antenna is tuned based at least in part on a diameter of the pressure vessel antenna. The diameter of the pressure vessel antenna may be set, in some embodiments, based on a target environment where the pressure vessel antenna is to be utilized. For example, in some embodiments, the pressure vessel antenna includes a diameter that maximizes available space of a borehole within which the pressure vessel antenna is located.

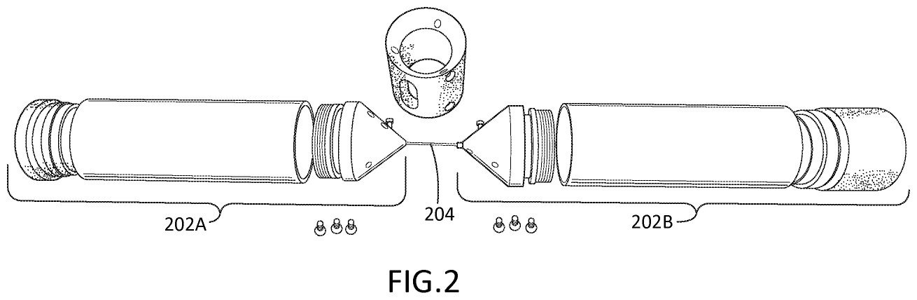

FIG. 2 illustrates an exploded view of arranged components of an example pressure vessel antenna in accordance with at least one embodiment of the present disclosure. For example, as illustrated, the components are arranged in the manner described above to form an end-capped and cone-tipped subassembly 202A and an end-capped and cone-tipped subassembly 202B. Each of the end-capped and cone-tipped subassemblies 202A and 202B are formed of a tube (e.g., one of the plurality of tubes 108) having a cone tip at one end (e.g., one of the plurality of cones 102) and an end cap at the other end (e.g., one of the caps 110A or 110B). As illustrated, for example, the end-capped and cone-tipped subassembly 202A may embody a bottom subassembly, including an open cap 110A, and the end-capped and cone-tipped subassembly 202B may embody a top subassembly, including the closed cap 110B. The end-capped and cone-tipped subassembly 202B does not include an extension container (e.g., any of the extension containers 104), however such components may be included in other implementations. The end-capped and cone-tipped subassembly 202A and 202B are connected by a feed cable 204 ran between the two subassemblies at a feedpoint. In some embodiments, the feed cable 204 at the feedpoint is embodied by a copper cable ran between the two subassemblies, for example a SubMiniature version A (SMA) connector, coaxial, or other RF connector. The feed cable 204 may include conductors that are coupled to each tube. In this regard, the connected assembly forms a dipole antenna. For example, in some embodiments, a shield part of the feed cable 204 may be connected to one pole and a core of the feed cable 204 is connected to the other pole.

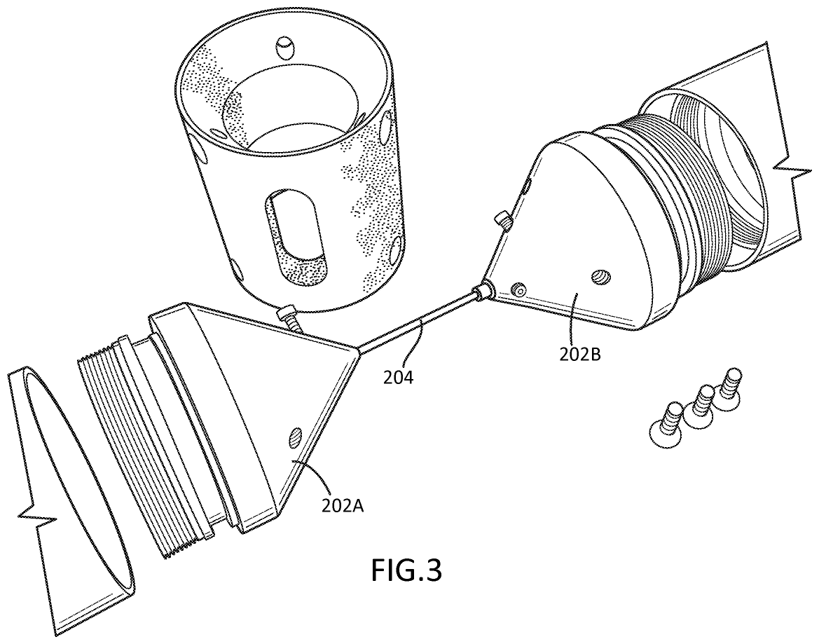

FIG. 3 illustrates a zoomed view of components at a feedpoint of an example pressure vessel antenna in accordance with at least one embodiment of the present disclosure. Specifically, FIG. 3 illustrates a zoomed in portion of the subassemblies depicted and described with respect to FIG. 2. The zoomed in view depicts the cones of the two subassemblies 202A and 202B together with the feed cable at the feedpoint and ran between the two cones thereof.

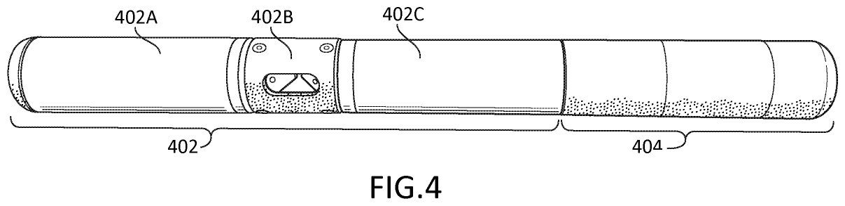

FIG. 4 illustrates components of a formed pressure vessel antenna in accordance with at least one embodiment of the present disclosure. Specifically, FIG. 4 depicts a pressure vessel antenna formed of the components depicted and described herein with respect to FIGS. 1-3.

The pressure vessel antenna includes a bottom subassembly 402A and a top subassembly 402C, the two subassemblies removably attached by a spacer 402B. The top subassembly 402C in some embodiments is configured to include any number of electronic components (e.g., RF signal producing and/or receiving components) within the interior cavity of the subassembly.

The pressure vessel antenna further includes a battery extension 404. The battery extension 404 is removably affixed to the top subassembly 402C, for example where the battery extension 404 threads into corresponding threads on an upper end of the top subassembly 402C. The set of interlocking threads in some embodiments further includes an o-ring or other sealing mechanism (e.g., positioned on grooves between the components) that facilitates an air-tight or liquid-tight seal between the two components connected via the set of interlocking threads. The battery extension 404 is comprised of a plurality of battery extension compartments and a closed cap. In some embodiments, each battery extension compartment of the battery extension 404 includes at least one battery that is electronically coupled to electronic circuitry within the top subassembly 402C. In this regard, the electronic circuitry within the top subassembly 402C draws power from the at least one battery within the battery extension 404. The battery extension 404 is sealed by a closed cap at the opposite end of the cone removably affixed to the top subassembly 402C.

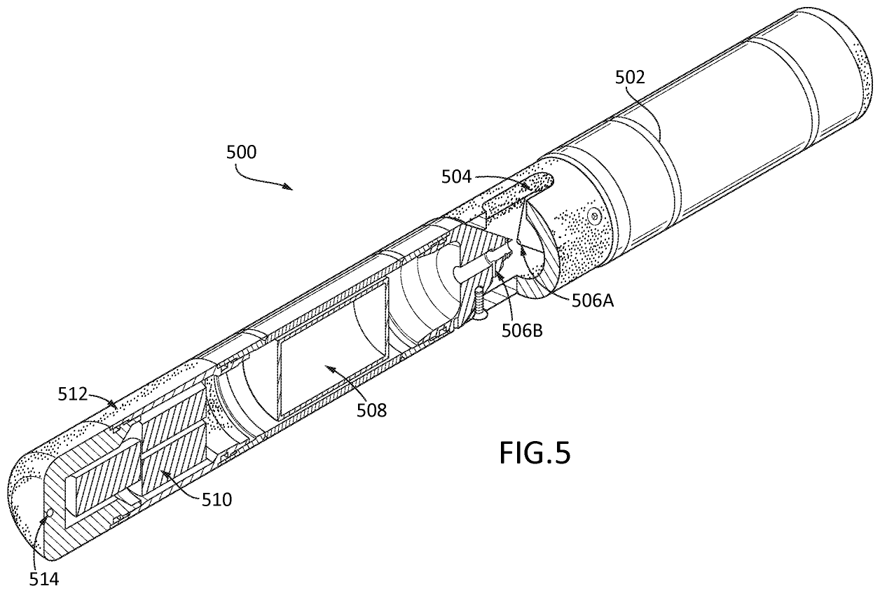

FIG. 5 illustrates a sliced internal view depicting components of a formed pressure vessel antenna in accordance with at least one embodiment of the present disclosure. Specifically, FIG. 5 depicts a cross-sectional view of an example pressure vessel container 500 in accordance with at least one example embodiment of the present disclosure. In some embodiments, the pressure vessel container includes electronic circuitry that enables functionality for receiving and/or transmitting RF signals.

As an initial matter, the pressure vessel container 500 includes a bottom subassembly 502. The bottom subassembly serves as a bottom half of the available interior space of the pressure vessel container 500. In some embodiments, the bottom subassembly 502 embodies an unpressurized environment, for example where the bottom subassembly 502 includes an open cap at an end of the subassembly and a cone at the other end. The cone of the bottom subassembly 502 faces the cone of the top subassembly discussed further herein. In some embodiments, the bottom subassembly 502 does not include any internal components or elements within the internal space of the subassembly. Instead, due to the open cap for example, a fluid from the environment of the pressure vessel container 500 may fill the cavity defined within an internal portion of the bottom subassembly 502. In some embodiments, the bottom subassembly 502 further includes an air hole positioned at an upper section of the tube of the subassembly. In this regard, the air hole may be of a sufficient size to enable air flow to escape from the interior cavity of the second tube. In this regard, such an air hole may serve as a pressure release as liquid (for example) enters from the open cap of the bottom subassembly 502.

The pressure vessel container 500 includes a spacer 504. The spacer 504 includes a feedpoint window that provides access to an interior cavity defined by the spacer 504. The spacer 504 may define the interior cavity of a defined size, for example based on a defined spaced, fixed distance that the spacer 504 is designed to separate a top subassembly and a bottom subassembly of the pressure vessel container 500. A cone tip of each of the top subassembly (e.g., cone 506B) and the bottom subassembly (e.g., cone 506A) may be removably affixed (e.g., “fit”) within the interior space defined by the spacer 504. The cone tips may be attached via a feed cable at a feedpoint that runs between the two cones of the top and bottom subassemblies, in some embodiments. In some embodiments, the cone 506B is hollow or semi-hollow, such that an interior cavity within the cone 506B is defined.

The top subassembly of the pressure vessel container 500 further includes a tube 508. The tube 508 embodies a longest portion of the top subassembly. The tube 508 defines an interior cavity within which electronic circuitry may be positioned. For example, RF signal producing and/or receiving components may be positioned within the interior cavity space defined by the tube 508 to maintain operation in a pressurized environment. In this regard, the top subassembly of the pressure vessel container 500 serves as a pressurized half of the pressure vessel container 500.

The top subassembly of the pressure vessel container 500 further includes at least one battery extension compartment 512. The battery extension compartment 512 as depicted defines an internal cavity within which one or more battery utilized to power electronic circuitry (e.g., RF signal producing and/or receiving components) may be positioned. For example, as illustrated, the battery extension compartment 512 includes batteries 510. Each of the batteries 510 may be chargeable or include a certain level of electrical charge that may be stored and later distributed to one or more components of electronic circuitry when activated. In some embodiments, the batteries 510 may be electronically coupled to electronic circuitry positioned within the remaining internal cavities of the top subassembly. The top subassembly may include any number of battery extension compartments, each having a defined internal cavity that stores any number of batteries 510 in any configuration that allows for distribution of power from such batteries to one or more other electronic circuitry positioned within an internal cavity of the top subassembly (e.g., components for RF signal producing and/or receiving).

The top subassembly further includes a closed cap 514. In some embodiments, the closed cap 514 defines an internal cavity within which additional electronic circuitry may be positioned. For example, as illustrated, in some embodiments the closed cap 514 defines an internal cavity within which at least one additional battery may be stored, for example in addition to the batteries 510 in the battery extension compartment 512. The closed cap 514 in some embodiments is closed at all points to ensure that the internal cavity formed by the components remains pressurized as compared to an environment outside the pressure vessel container 500. The closed cap 514 further includes a lift point 516. The lift point 516 may be utilized for manipulation and/or other manipulation of the pressure vessel container 500, for example to drop a pressure vessel antenna (including the pressure vessel container 500 as a housing) into a borehole.

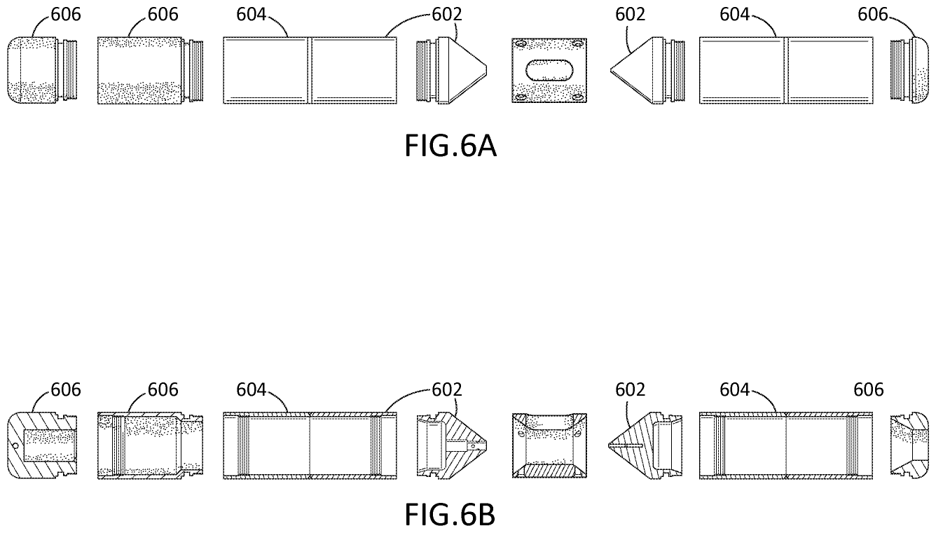

FIGS. 6A-6B illustrate an exploded view of components with particular materials of another pressure vessel container, for example utilized in housing electronic components of a pressure vessel antenna, in accordance with at least one embodiment of the present disclosure. Specifically, FIGS. 6A-6B illustrate example materials for the various components depicted and described with respect to FIGS. 1-5. It should be appreciated that, in some embodiments, the material of the various components may match on an interior and an exterior of the component.

As illustrated, FIGS. 6A-6B includes a plurality of metal components 602. The plurality of metal components 602 in some embodiments are comprised of aluminum, which provides sufficient rigidity of the pressure vessel container while further serving as a suitable antenna material (without significantly negatively impacting the RF signals produced by RF signal producing and/or receiving components positioned within the pressure vessel container). As illustrated, the plurality of metal components 602 includes the cones of each of the top subassembly and the bottom subassembly, and the main tube of each subassembly.

In some embodiments, one or more metal components may be permanently affixed to one another. For example, as illustrated, in some embodiments two tube subcomponents are welded together at welded seams 604. The two welded subcomponents are welded to prevent the metal subcomponents from separating. The seam may be comprised of the same metal, or in some embodiments includes one or more additional materials that facilitate the fusing of the two subcomponents.

FIGS. 6A-6B further includes a plurality of thermoplastic components 606. For example, in some embodiments, each of the plurality of thermoplastic components 606 is comprised of nylon. The nylon components may be sufficiently rigid not to lose structure, and may similarly avoid negatively impacting the operation of RF signal producing and/or receiving components within the pressure vessel container for RF signal transmitting and/or receiving. As illustrated, the plurality of thermoplastic components 606 includes a spacer, optionally at least one battery extension compartment, and/or each end cap of the top and bottom subassemblies.

It should be appreciated that the various removably affixable components advantageously provides modularity, repairability, and ease of use to embodiments of the present disclosure. For example, components may be removed for inclusion of RF signal producing and/or receiving components within a pressure vessel container to form a pressure vessel antenna. Additionally or alternatively, in some embodiments, particular materials (e.g., aluminum and nylon, in some embodiments) are utilized to ensure that the pressure vessel container maintains its structure in a pressurized environment without preventing sufficient RF signal transmission and/or reception.

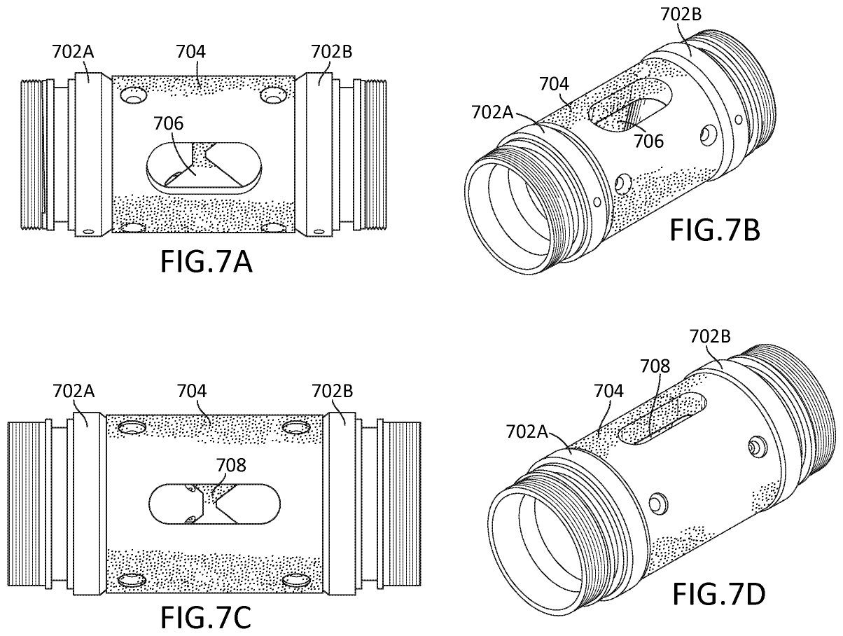

FIGS. 7A-7D illustrate extracted, zoomed views of a feedpoint location of an example pressure vessel antenna in accordance with at least one embodiment of the present disclosure. Specifically, FIG. 7A-7D depicts a zoomed view of a spacer 704 at which a top subassembly and a bottom assembly meet, for example such that the top subassembly and the bottom subassembly are removably affixed (or “fit”) within the spacer 704.

The spacer 704 receives each cone tip of a top subassembly and a bottom subassembly. For example, the cone 702A corresponds to a cone tip of the top subassembly, and the cone 702B corresponds to a cone tip of the bottom subassembly (repeated depiction of the remaining components of each subassembly is omitted). Each of these cones 702A and 702B is fit into the spacer 704, such that each of the cones is removably affixed to the spacer 704 at a particular position. The spacer 704 may be configured to removably affix each of the cones 702A and 702B at particular defined positions, such that the spacer 704 creates a defined space that separates the cones 702A and 702B when such cones are set within the spacer 704.

In some embodiments, the spacer 704 includes one or more feedpoint windows. Each feedpoint window enables access to an interior cavity defined by the spacer 704. For example, as illustrated, the spacer 704 includes a feedpoint window. In some embodiments, the feedpoint window includes a first feedpoint window 706. In some embodiments, the feedpoint window includes a second feedpoint window 708. The first feedpoint window 706 or the second feedpoint window 708 may be included based on a desired size for accessing the interior cavity of the spacer 704. Additionally or alternatively, in some embodiments, the first feedpoint window 706 or the second feedpoint window 708 is selected based on a size, a diameter, or other metric of the spacer 704, for example where longer components may include a longer feedpoint window. In some embodiments, a spacer 704 includes multiple feedpoint windows, which may include the same or different levels of access to the interior cavity defined by the spacer 704. The first feedpoint window 706, for example, may be wider but less long than the second feedpoint window 708. It should be appreciated that, in other embodiments, other and/or additional feedpoint windows may be included in the spacer 704, and/or other configurations and/or shapes of feedpoint windows may be included in the spacer 704.

Whether via the first feedpoint window 706 or the second feedpoint window 708, each of the feedpoint windows 706 or 708 provide access to an interior cavity of the spacer 704, for example for providing and/or positioning a feed cable at a feedpoint within the interior cavity. In some embodiments, one or more feedpoint windows may be accessed to place a feed cable within the interior cavity defined by the spacer 704. Additionally or alternatively, in some embodiments, the feedpoint window may be accessed to position the feed cable at the feedpoint within the interior cavity, for example such that the cable runs between the cones 702A and 702B. In some embodiments, at least one feedpoint window is further utilized to seal the internal cavity defined by the spacer 704 (e.g., the feedpoint and/or a surrounding volume), for example to ensure an air-tight or liquid-tight seal and/or to maintain a particular pressure.

In some embodiments, the interior space defined within the spacer 704 is sealed. Such a seal may be utilized to make the volume of the interior space pressurized to a particular pressure, and/or to prevent liquid from entering the interior space and negatively impacting component operation of any component within the space. For example, in a circumstance where a feedpoint includes a feed cable that enters a tube subassembly through a port in a corresponding cone, such a port would be vulnerable to impact from fluid in an environment if not properly sealed. In some embodiments, the spacer includes a sealed interior cavity, which may be formed by potting the interior cavity in epoxy, or otherwise securing a sealed containment mechanism in the open spaces defined within the spacer 704 (e.g., using gaskets and/or the like).

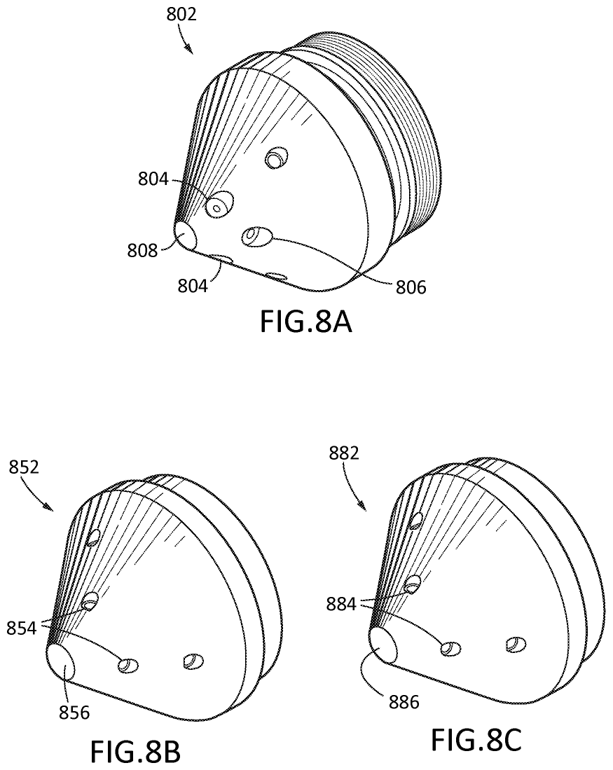

FIGS. 8A-8C illustrates extracted, zoomed views of example cones utilized in example pressure vessel containers in accordance with at least one embodiment of the present disclosure. Specifically, FIGS. 8A-8C depict multiple cone configurations, which may be utilized in different embodiments and/or utilized in combination with one another in particular embodiments.

As illustrated, FIGS. 8A-8C includes a cone for braided shield cable 802. The cone for braided shield cable 802 includes a threaded end that facilitates removably affixing the cone to another component having corresponding threads, for example a tube of a tubular subassembly for a pressure vessel container. The set of interlocking threads in some embodiments further includes an o-ring or other sealing mechanism (e.g., positioned on grooves between the components) that facilitates an air-tight or liquid-tight seal between the two components connected via the set of interlocking threads. The cone for braided shield cable 802 further includes terminals 804. The terminals 804 are shield ends of the cone for braided shield cable 802.

The cone for braided shield cable 802 further includes set screw 806. The set screw 806 enables a setting and/or adjusting of a cable positioned with respect to the cone for braided shield cable 802. For example, the set screw 806 may be engaged (e.g., rotated) to a first position to fix the position of a braided shield cable positioned within the cone for braided shield cable 802 (e.g., between a spacer), and may be engaged to a second position (e.g., rotated counterclockwise) to enable a reverse adjustment to a position of the braided shield cable positioned within the cone for braided shield cable 802.

The cone for braided shield cable 802 includes a cable reception port 808. In some embodiments, the cable reception port 808 is of a particular diameter designed to fit at least a target cable size. For example, the cable reception port 808 in some embodiments is embodied by a channel that fits at least a feedpoint cable that connects the cone for braided shield cable 802, or electronic circuitry (e.g., RF signal producing and/or receiving components) within a tube removably affixed to the cone for braided shield cable 802, with another tube subassembly or cone thereof. In this regard, the cable reception port 808 is designed to provide access to an interior portion of the cone for braided shield cable 802.

FIGS. 8A-8C further include a cone for smooth shield cable 852. The cone for smooth shield cable 852 does not include any threaded end, for example where the end of the cone is instead smooth fit into a corresponding circular receiving end of a corresponding tube. The cone for smooth shield cable 852 includes set screws 854. In some embodiments, the set screws 854 are configured to penetrate an insulation of another component, for example cable insulation within the cone, to removably affix a position of the cone for smooth shield cable 852.

The cone for smooth shield cable 852 further includes a cable reception port 856. In some embodiments, the cable reception port 856 is of a particular cable diameter. In this regard, the cable (e.g., a feedpoint cable) in some embodiments fills the entire space defined by the cable reception port 856.

FIGS. 8A-8C further include a cone for helical shield cable 882. The cone for helical shield cable 882 in some embodiments is of a particular design and/or shape that enables the cone to be removably affixed (e.g., fit) into a corresponding subassembly (e.g., a tube of a top subassembly of a pressure vessel container, for example). The cone for helical shield cable 882 similarly includes a plurality of set screws 884, which enable setting of a position of the cone. Additionally, in some embodiments, the cone for helical shield cable 882 includes a threaded cable reception port 886. The threaded cable reception port 886 in some embodiments is threaded to match corresponding threads of a cable (e.g., at a feedpoint) to be positioned within the threaded cable reception port 886. For example, in an example embodiment where a copper jacketed feedpoint cable is utilized, the threaded cable reception port 886 may include threads that correspond to matching threads of the copper jacket of the feedpoint cable. In some embodiments, the narrow part of the cone receives the corresponding cable, for example where a copper helical jacket interfaces with the corresponding threads of the cone. The port and cable may then be sealed via epoxy potting. In this regard, the feedpoint cable may be provide a pressurized fit when properly removably affixed within the threaded cable reception port 886.

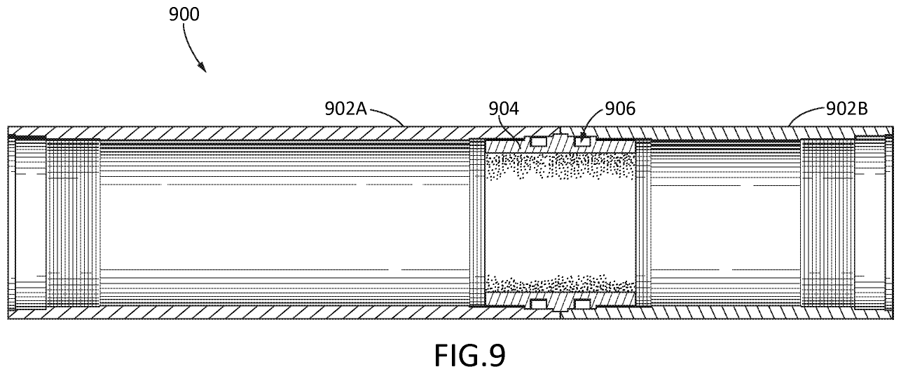

In some embodiments, one or more components may be coupled together. For example, tube-shaped components that extend a full length of a tube subassembly (e.g., one of two tube subassemblies that are fed into a spacer, where one of the tube subassemblies is pressurized for storing RF signal producing and/or receiving components) may be coupled together to enable an extended length. FIG. 9 illustrates an extracted, zoomed view of coupled extension sections of an example pressure vessel container in accordance with at least one embodiment of the present disclosure. Specifically, FIG. 9 depicts a zoomed in view of an example extension section 900. The extension section 900 may be a tube of a particular subassembly, for example forming a length of a top subassembly that includes RF signal producing and/or receiving components (e.g., electrical circuitry for transmitting and/or receiving RF signals).

As depicted, the extension section 900 includes a first tube 902A and a second tube 902B. The first tube 902A and the second tube 902B may each define an interior cavity, for example within which electronic circuitry may be positioned for operation. In some embodiments, each of the first tube 902A and the second tube 902B are comprised of aluminum, each forming an aluminum cylindrical tube with a defined interior cavity.

The extension section 900 further includes a brass coupler 904. The brass coupler 904 connects the first tube 902A with the second tube 902B. In some embodiments, the first tube 902A and/or the second tube 902B are removably affixed to the brass coupler 904 via threads of the tube engaging corresponding threads of the brass coupler 904. Additionally or alternatively, in some embodiments, the coupler 904 is fit in place via force or another connecting mechanism. Additionally or alternatively, in some embodiments, the coupler 904 engages one or more groove 906. In some embodiments, the one or more groove 906 embodies an o-ring groove that is specially configured to provide an air-tight or otherwise leakproof seal between the coupler 904 and each of the tubes 902A and 902B. In this regard, an o-ring may be compressed into the o-ring groove 906, forming the seal and enabling a pressurized environment internal to the tubes 902A/902B and the coupler 904. It should be appreciated that any number of tubes may be connected with any number of connectors, enabling a tube subassembly to be formed of any desired length.

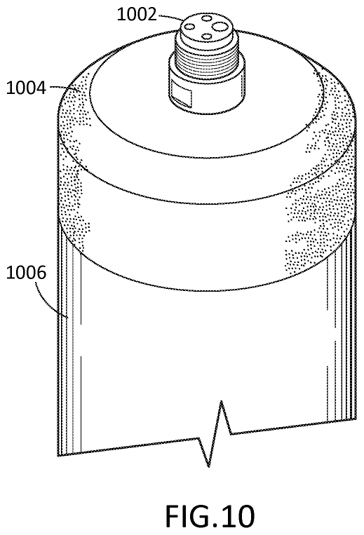

In some embodiments, one or more alternative configurations may be utilized to enable communications of signals to and/or from electronic circuitry (e.g., RF signal producing and/or receiving components) positioned within a pressure vessel container. For example, in some embodiments, at least a portion of the RF signal producing and/or receiving components of a pressure vessel antenna are configured to communicate at least in part utilizing a specialized end cap port. FIG. 10 illustrates an end cap having an electronic communications port of an example pressure vessel antenna in accordance with at least one embodiment of the present disclosure.

Specifically, FIG. 10 depicts a specialized end cap 1004. The specialized end cap 1004 is positioned at an end of a tube 1006. The tube 1006 may form a main body component of an example tube subassembly, for example a top subassembly of a pressure vessel antenna. The tube 1006 may include a cone tip located at the other end (not depicted) that is removably affixed by interfacing with a spacer in some embodiments.

The specialized end cap 1004 is a nylon end cap, for example constructed in the manner depicted and described herein. The specialized end cap 1004 is further specially configured to include an electronic communications port 1002. The electronic communications port 1002 as depicted is centered, such that the orientation of the communication port 1002 is parallel with the orientation of the tube 1006. It should be appreciated that the electronic communications port 1002 may be any port configured to receive a wired connection. In this regard, the electronic communications port 1002 may include any number and/or configuration of receptacle slots, pins, connections, and/or the like. Similarly, the electronic communications port 1002 may be configured to facilitate signal transmission and/or reception in accordance with a particular wired communications protocol. In this regard, it should be appreciated that in some embodiments, the electronic communications port 1002 may be of a different configuration than the configuration depicted in FIG. 10 without deviating from the scope and spirit of this disclosure.

The pressure vessel antenna described herein may be utilized in a particular process for measuring RF response associated with an environment, for example glacial ice. The process in some embodiments is performed as a computer-implemented method, for example in whole or in part using the components depicted and described herein. For example, in some embodiments, the process is performed by a system including a surface-level system and at least one pressure vessel antenna disposed into a borehole.

The process includes generating, from a surface-level system, a radio pulse cascade in an environment. In some embodiments, the radio pulse cascade is caused by creation and emission of a particle cascade into the environment, such as a particle cascade emitted into glacial ice to be observed. The process further includes receiving energy of the radio pulse cascade by at least one pressure vessel antenna. The pressure vessel antenna may read energy received at the pressure vessel antenna while the pressure vessel antenna is in a borehole, for example. The process further includes communicating, from the pressure vessel antenna, data indicating the energy received at the pressure vessel antenna. The pressure vessel antenna may communicate data representing the measured energy level using a wireless communication scheme, or in some embodiments using a wired communication scheme (e.g., via a wired communication port on the pressure vessel antenna that is connected to a wired connection). The read energy level may be communicated to the same surface-level system for processing, and/or to another surface-level system for processing, for example. In some embodiments, the pressure vessel antennas are utilized to read energy received at particular intervals as the pressure vessel antenna is lowered into a borehole. In some such embodiments, the read data representing the energy received by the pressure vessel antenna at different intervals may be processed to determine characteristics of construction of the environment (e.g., glacial ice), anomalous portions of the environment, and/or the like.

### III. IMPLEMENTATIONS

Certain implementations of systems and methods consistent with the present disclosure are provided as follows:

Embodiment 1. A pressure vessel antenna (PVA) comprising: a first tube comprising a first cone removably affixed to an end of the first tube, and a second tube comprising a second cone removably affixed to an end of the second tube, wherein the first tube and the second tube form a dipole antenna by each being coupled to one conductor of a feed cable extending between the first cone and the second cone, wherein the first tube and the second tube are separated by a fixed distance using a spacer; and electronic circuitry disposed in the first tube, wherein the electronic circuitry is connected to the feed cable.

Embodiment 2. The PVA according to Embodiment 1, wherein a full length of the PVA is tuned to a resonant frequency produced via the electronic circuitry.

Embodiment 3. The PVA according to any one of Embodiments 1-2, wherein a diameter of the PVA corresponds to a borehole diameter, and a signal bandwidth produced via the electronic circuitry is based at least in part on the diameter of the PVA.

Embodiment 4. The PVA according to any one of Embodiments 1-3, wherein the first tube comprises tube at a first pressure, and the second tube comprises an open tube at a second pressure, wherein the first pressure differs from the second pressure.

Embodiment 5. The PVA according to any one of Embodiments 1-4, wherein the first tube and the second tube taper at an angle to a feedpoint corresponding to the feed cable.

Embodiment 6. The PVA according to Embodiment 5, wherein the angle is in a range between 40 degrees and 75 degrees.

Embodiment 7. The PVA according to any one of embodiments 1-6, further comprising: at least one battery extension compartment removably affixed to the first tube, wherein the at least one battery extension compartment comprises at least one battery that powers the electronic circuitry.

Embodiment 8. The PVA according to any one of Embodiments 1-7, wherein the spacer comprises a sealed interior cavity.

Embodiment 9. The PVA according to any one of Embodiments 1-8, wherein the first cone and the second cone are removably affixed using a removable attachment mechanism.

Embodiment 10. The PVA according to Embodiment 9, wherein the removable attachment mechanism comprises a set of interlocking threads.

Embodiment 11. The PVA according to any one of Embodiments 1-10, further comprising: a ballast.

Embodiment 12. The PVA according to any one of Embodiments 1-11, wherein the second tube further comprises: an air hole positioned at an upper section of the second tube, wherein the air hole enables air flow to escape from inside the second tube.

Embodiment 13. The PVA according to any one of Embodiments 1-12, wherein the first tube comprises an electronic communications port.

Embodiment 14. The PVA according to any one of Embodiments 1-13, further comprising: at least one extension section removably affixed to the first tube or the second tube by at least one coupler.

Embodiment 15. The PVA according to any one of Embodiments 1-14, further comprising: a durable polymer end cap removably affixed to the first tube.

Embodiment 16. The PVA according to any one of Embodiments 1-15, wherein the first cone comprises an aluminum cone.

Embodiment 17. A pressure vessel antenna container comprising: a first tube comprising a first cone removably affixed to an end of the first tube, and a second tube comprising a second cone removably affixed to an end of the second tube; a spacer between the first tube and the second tube, wherein the spacer separates the first tube and the second tube by a fixed distance; and a feedpoint on the spacer, wherein the feedpoint is between the first tube and the second tube.

Embodiment 18. The pressure vessel antenna container of Embodiment 17, wherein the first cone is aluminum.

Embodiment 19. The pressure vessel antenna container of any one of Embodiments 17-18, further comprising: a durable polymer end cap removably affixed to the first tube.

Embodiment 20. The pressure vessel antenna of Embodiment 18, wherein the diameter of the pressure vessel antenna container fits within a borehole.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A pressure vessel antenna (PVA) comprising:
a first tube comprising a first cone removably affixed to an end of the first tube, and a second tube comprising a second cone removably affixed to an end of the second tube,
wherein the first tube and the second tube form a dipole antenna by each being coupled to one conductor of a feed cable extending between the first cone and the second cone,
wherein the first tube and the second tube are separated by a fixed distance using a spacer; and
electronic circuitry disposed in the first tube,
wherein the electronic circuitry is connected to the feed cable.

2. The PVA according to claim 1, wherein a full length of the PVA is tuned to a resonant frequency produced via the electronic circuitry.

3. The PVA according to claim 1, wherein a diameter of the PVA corresponds to a borehole diameter, and a signal bandwidth produced via the electronic circuitry is based at least in part on the diameter of the PVA.

4. The PVA according to claim 1, wherein the first tube comprises tube at a first pressure, and the second tube comprises an open tube at a second pressure, wherein the first pressure differs from the second pressure.

5. The PVA according to claim 1, wherein the first tube and the second tube taper at an angle to a feedpoint corresponding to the feed cable.

6. The PVA according to claim 5, wherein the angle is in a range between 40 degrees and 75 degrees.

7. The PVA according to claim 1, further comprising:
at least one battery extension compartment removably affixed to the first tube,
wherein the at least one battery extension compartment comprises at least one battery that powers the electronic circuitry.

8. The PVA according to claim 1, wherein the spacer comprises a sealed interior cavity.

9. The PVA according to claim 1, wherein the first cone and the second cone are removably affixed using a removable attachment mechanism.

10. The PVA according to claim 9, wherein the removable attachment mechanism comprises a set of interlocking threads.

11. The PVA according to claim 1, further comprising:
a ballast.

12. The PVA according to claim 1, wherein the second tube further comprises:
an air hole positioned at an upper section of the second tube, wherein the air hole enables air flow to escape from inside the second tube.

13. The PVA according to claim 1, wherein the first tube comprises an electronic communications port.

14. The PVA according to claim 1, further comprising:
at least one extension section removably affixed to the first tube or the second tube by at least one coupler.

15. The PVA according to claim 1, further comprising:
a durable polymer end cap removably affixed to the first tube.

16. The PVA according to claim 1, wherein the first cone comprises an aluminum cone.

17. A pressure vessel antenna container comprising: a first tube comprising a first cone removably affixed to an end of the first tube, and a second tube comprising a second cone removably affixed to an end of the second tube; a spacer between the first tube and the second tube, wherein the spacer separates the first tube and the second tube by a fixed distance; and a feedpoint on the spacer, wherein the feedpoint is between the first tube and the second tube.

18. The pressure vessel antenna container of claim 17, wherein the first cone is aluminum.

19. The pressure vessel antenna container of claim 17, further comprising:
a durable polymer end cap removably affixed to the first tube.

20. The pressure vessel antenna of claim 18, wherein a diameter of the pressure vessel antenna container fits within a borehole.
